(19) United States
(12) Patent Application Publication
(10) Pub. No.: US 2005/0226305 A1
(43) Pub. Date: Oct. 13, 2005

(54) Laser beam projection device having a rotary locking structure

(76) Inventor: Chao Fa Hsu, Tanzih Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/820,718

(22) Filed: Apr. 9, 2004

(51) Int. Cl. H01S 3/00

(52) U.S. Cl. 372/109

(57) ABSTRACT

This laser beam projection device has a rotary locking structure. It has a base, a working portion and two rotary locking portions. The base has a contacting surface to contact a wall or ceiling. Each rotary locking portion has a hand knob spaced from the contacting surface so the hand can easy rotate the hand knob. The applied force finally will concentrate on a conical section so that it can insert or sting in the wall easily. Also, by the screw and thread cooperating design, the conical section can easily insert in the wall. It saves effort for the user's hand. Also, it has an easy rotary locking design.

### BACKGROUND OF INVENTION

1. Field of the Invention

This invention relates to a laser beam projection device. Particularly, it relates to a laser beam projection device having a rotary locking structure. It saves effort and can be operated by one hand. In addition, it has an easy rotary locking design.

2. Description of the Prior Art

Referring to FIG. 5, it illustrates laser beam projection device and its securing structure. It comprises a fixing frame 80 and a laser beam projection device 90.

About the fixing frame 80, it includes:
a substantially rectangular flat plate 81 for securing the fixing frame 80 on a wall;
a fixing hole 82 penetrating the flat plate 81, so that it allows a nail to secure the entire fixing frame 80 on the wall;
two fixing portions 83 that are formed by directly bending two ends of the flat plate 81.

Concerning the laser beam projection device 90, it can emit a horizontal or vertical reference laser beam. Two ends of the laser beam projection device 90 are secured on the fixing portions 83 of the fixing frame 80.

However, the traditional device has the following disadvantages:

[1] It needs an extra hand tool to fix this fixing frame on the wall. About the traditional device, the user has to take a hammer to hammer the nail in the wall. Otherwise, the fixing frame cannot be secured on the wall. When one hand takes the hammer, the other hand should hold the nail. Under such circumstance, there is no hand to hold the fixing frame 83. During such hammering process, it is easy to hurt the user's hand. And the depth of the nail inside the wall is not easy to be controlled.

[2] It needs great effort. The traditional fixing frame is secured by nail, so it needs great effort to force the nail into the wall. The nail might be tilted or dropped down during the hammering process. It is quite inconvenient.

### SUMMARY OF THE INVENTION

The primary object of the present invention is to provide a laser beam projection device having a rotary locking structure. It saves effort and can be operated by one hand.

Another object of the present invention is to provide a laser beam projection device having a rotary locking structure. By the cooperating design of screw section and threaded hole, the rotary force will be converted into a strong inserting force. Thus, it has an easy rotary locking design.

In order to achieve above-mentioned objects, a laser beam projection device having a rotary locking structure is provided. 1. A laser beam projection device having a rotary locking structure, comprising:

(a) a base having an outer surface, an inner surface, a first end, and a second end; said base including:
a contacting surface disposed on said outer surface of said base for securing said base;
two first guiding portions communicating said outer surface of said base with said inner surface of said base, each of said first guiding portion having a first diameter, said two first guiding portions being substantially equally spaced from said first end and said second end respectively, a predetermined height being disposed between said first guiding portion and said contacting surface;
two second guiding portions aligned with said first guiding portions and communicating said inner surface of said base with said outer surface of said base respectively, each of said second guiding portions having a second diameter less than said first diameter;
two threaded holes disposed on said base and positioned between said first guiding portion and said second guiding portion, each threaded hole having a plurality of tilted pushing surfaces;

(b) a working portion at least containing a vertical laser beam projection unit and horizontal laser beam projection unit;

(c) two rotary locking portion, each of said rotary locking portion having a hand knob, a guiding section, a threaded section, a working section, and a conical section; wherein

said hand knob having a hand knob diameter and connected with said guiding section,

said guiding section having an outer diameter approximately equal to said first diameter of said first guiding portion,

said screw section being corresponding to said threaded hole, said screw section having a plurality of tilted cooperating surfaces, and a direction from said screw section to said working section being defined as a locking direction,

said working section having a working diameter approximately equal to said second diameter but far less than said hand knob diameter, said working section extending through said second guiding portion of said base and protruding over said outer surface of base; and

said conical section having a conical shape for firmly securing.

### BRIEF DESCRIPTION OF THE DRAWINGS

FIG. 1 is a perspective view of the present invention when some portion of the housing is removed;

FIG. 2 is a perspective view of the rotary locking portion;

FIG. 3 is an enlarged view about a selected portion of the present invention;

FIG. 4 is a cross-sectional view showing this invention is secured on the wall; and

FIG. 5 is a perspective view of a traditional laser level device.

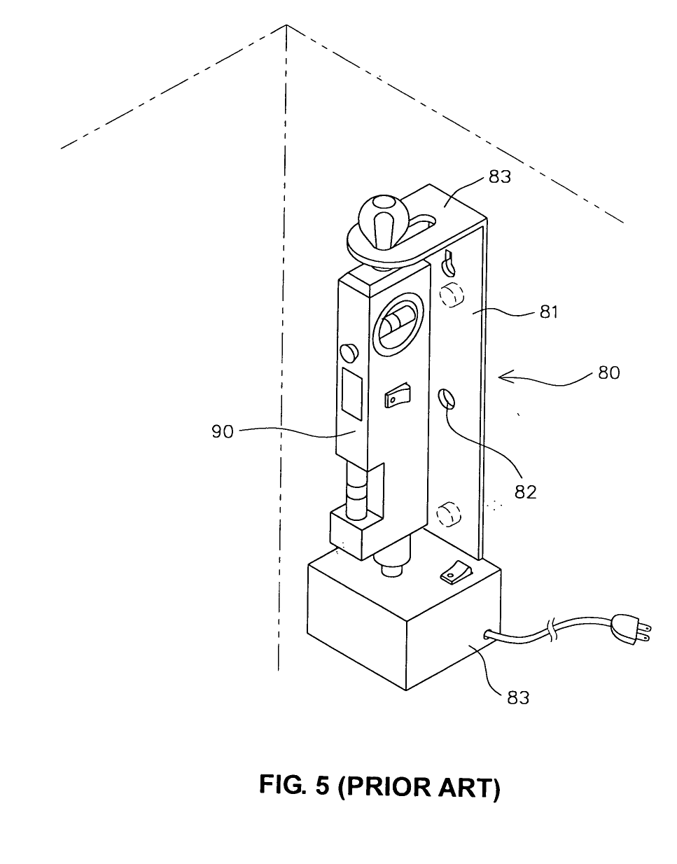

### DETAILED DESCRIPTION OF THE PREFERRED EMBODIMENT

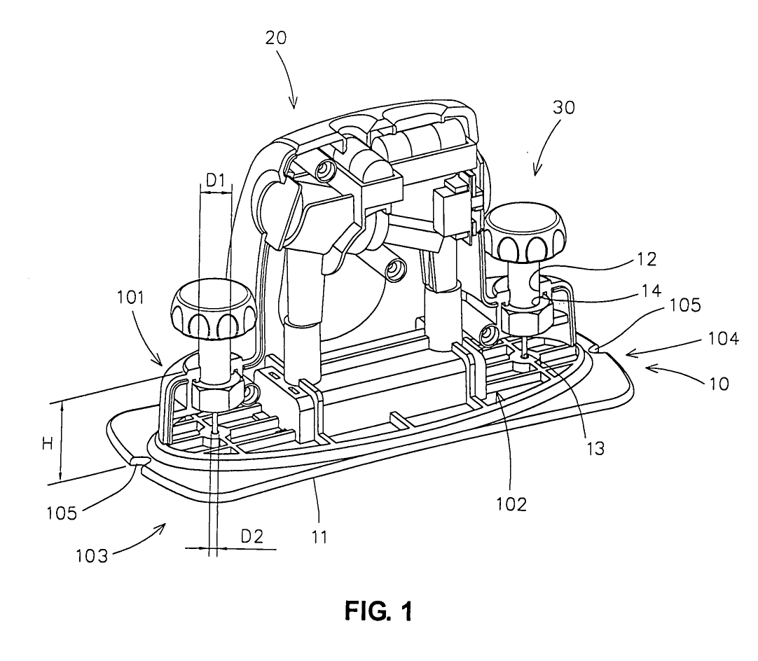

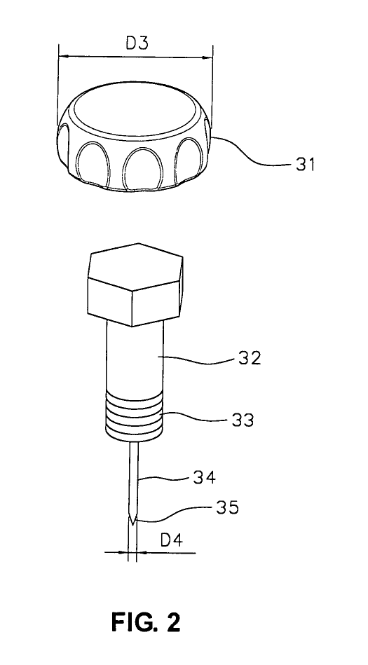

Referring to FIGS. 1 and 2, the present invention is a laser beam projection device having a rotary locking structure. It mainly comprises a base 10, a working portion 20 and two rotary locking portions 30.

With regard to this base 10, it has an outer surface 101, an inner surface 102, a first end 103, a second end 104, and two fixing recesses 105 (or more fixing recesses 105 substantially distributed on the first end 103 and the second end 104 of the base 10.). The base includes:

(1) a contacting surface 11 disposed on the outer surface 101 of the base 10 for securing said base;

(2) two first guiding portions 12 communicating the outer surface 101 of the base 10 with the inner surface 102 of the base 10. Each of the first guiding portion 12 having a first diameter D1. These two first guiding portions 12 are substantially equally spaced from the first end 103 and from the second end 104 respectively. A predetermined height H is disposed between the first guiding portion 12 and the contacting surface 11.

(3) two second guiding portions 13 aligned with the first guiding portions 12 and communicating the inner surface 102 of the base 10 with the outer surface 101 of the base 10 respectively. Each of the second guiding portions 13 having a second diameter D2 less than the first diameter D1.

(4) two threaded holes 14 disposed on the base 10 and positioned between the first guiding portion 12 and the second guiding portion 13. Each threaded hole 14 has a plurality of tilted pushing surfaces 141.

About the working portion 20, it at least contains a vertical laser beam projection unit and horizontal laser beam projection unit.

Concerning these two rotary locking portions 30, as shown in FIG. 2, each of the rotary locking portion 30 has a hand knob 31, a guiding section 32, a threaded section 33, a working section 34, and a conical section 35.

The hand knob 31 has a hand knob diameter D3 and connected with the guiding section 32.

The guiding section 32 has an outer diameter approximately equal to the first diameter D1 of the first guiding portion 12.

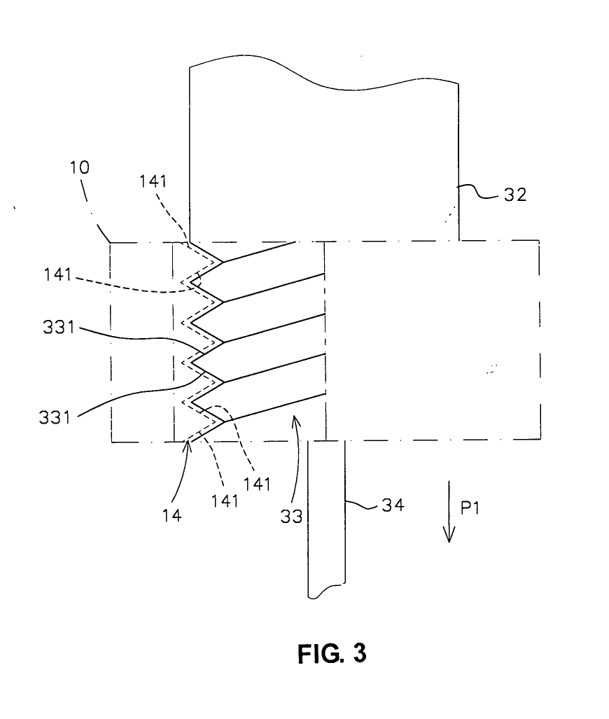

The screw section 33 is corresponding to the threaded hole 14. The screw section 33 has a plurality of tilted cooperating surfaces 331 (referring to FIG. 3). Furthermore, a direction from the screw section 33 to the working section 34 is defined as a locking direction P1.

The working section 34 has a working diameter D4 (as shown in FIG. 2) approximately equal to the second diameter D2 but far less than the hand knob diameter D3. In addition, the working section 34 extends through the second guiding portion 13 of the base 10 and protrudes over the outer surface 101 of base 10.

The conical section 35 has a conical shape for firmly securing (such as on a wall or on a ceiling).

The above description is about the structure of this invention.

The actual operation of this invention can be understood by the following description.

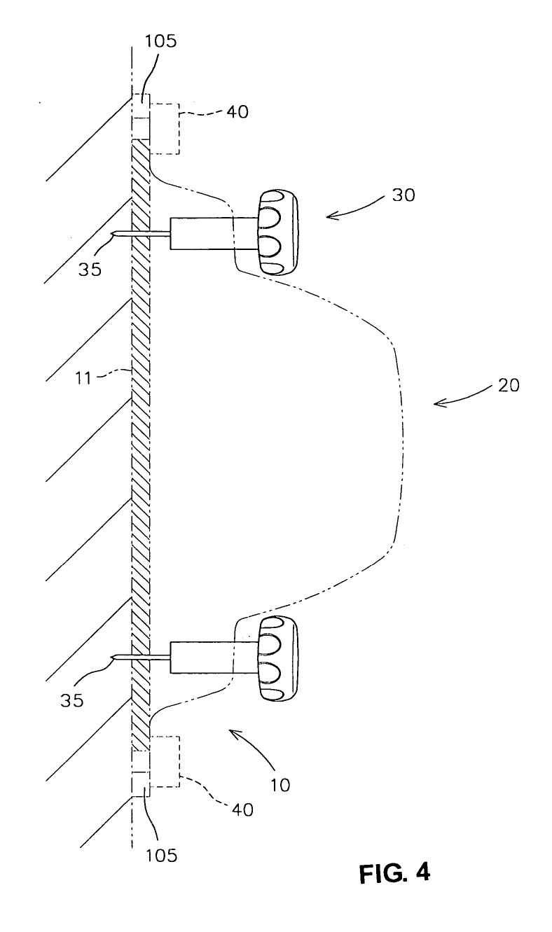

First, the user finds a desired position on a wall (as shown in FIG. 4) and moves the contacting surface 11 of the base 10 to contact with the wall (and then hold it there). The user rotates the hand knob 31 of the rotary locking portion 30 by one hand so that the guiding section 32 is rotating accordingly (see FIG. 3).

Once the guiding section 32 is rotated, the screw section 33 will cooperate with the threaded hole 14. About the rotation of the screw section 33, the screw section 33 contains several cooperating surfaces 331 that contact with the pushing surfaces 141. When the user rotates the hand knob 31, the screw section 33 and the conical section 25 will move toward the locking direction P1.

By repeated rotating the hand knob 31 toward the locking direction P1, the working section 34 and the conical section 35 will insert (or sting) in the wall and this invention can be secured on the wall (see FIG. 4) easily.

As shown in FIG. 4, it is another embodiment of this invention. Two (or more) fixing recesses 105 are formed on or near the first end 103 and the second end 104 respectively. In addition, by cooperating two fixing elements 40. Particularly, when the wall is wooden, these two fixing recess 105 are suitable for securing this invention on the wall by these two fixing elements 40. Besides, if cooperating with the rotary locking portion 30, the combined securing effect will be significantly enhanced.

Furthermore, there is a predetermined height H disposed between the first guiding portion 12 and the contacting surface 11. Therefore, it has enough space for the user's hand and fingers to rotate. Also, it allows the user to firmly hold on the hand knob 31 to apply suitable rotating force thereon. Also, two hand knobs 31 are evenly distributed near the first end 103 and the second end 104 respectively. So, the overall securing effect is excellent.

In addition, the cross-sectional area of the working section 34 or the conical section 35 is relatively small so that the force applied by the hand can transmit and concentrate on this small area. It will save the force of the user to compulsively insert it into the wall.

The improvements of this invention can be summarized as follows:

[1] It saves effort and can be operated by one hand. Due to the height between the first guiding portion and the contacting surface, there is a space allowing the user's hand to rotate. Therefore, the user can uses one's single hand to rotate the hand knob without any other hand tool. By the design of the larger hand knob and thin working section, the applied force finally arrives and concentrates on the working section with relatively small cross sectional area. Thus, it will save effort and can be operated by one hand.

[2] It has an easy rotary locking design. In this invention, the rotary locking portion contains a screw section that is cooperated with a threaded hole of the base. By the sloped contacting interface(s), the tilted pushing surfaces directly contact with the tilted cooperating surfaces. So, once the rotary locking portion is rotated, the rotary locking portion will move toward the wall compulsively. That achieves the function of easily securing on the wall.

The above embodiments are only used to illustrate the present invention, not intended to limit the scope thereof. Many modifications of the above embodiments can be made without departing from the spirit of the present invention.

1. A laser beam projection device having a rotary locking structure, comprising:
(a) a base having an outer surface, an inner surface, a first end, and a second end; said base including:
a contacting surface disposed on said outer surface of said base for securing said base;
two first guiding portions communicating said outer surface of said base with said inner surface of said base, each of said first guiding portion having a first diameter, said two first guiding portions being substantially equally spaced from said first end and said second end respectively, a predetermined height being disposed between said first guiding portion and said contacting surface;
two second guiding portions aligned with said first guiding portions and communicating said inner surface of said base with said outer surface of said base respectively, each of said second guiding portions having a second diameter less than said first diameter;
two threaded holes disposed on said base and positioned between said first guiding portion and said second guiding portion, each threaded hole having a plurality of tilted pushing surfaces;
(b) a working portion at least containing a vertical laser beam projection unit and horizontal laser beam projection unit;
(c) two rotary locking portion, each of said rotary locking portion having a hand knob, a guiding section, a threaded section, a working section, and a conical section; wherein
said hand knob having a hand knob diameter and connected with said guiding section,
said guiding section having an outer diameter approximately equal to said first diameter of said first guiding portion,
said screw section being corresponding to said threaded hole, said screw section having a plurality of tilted cooperating surfaces, and a direction from said screw section to said working section being defined as a locking direction,
said working section having a working diameter approximately equal to said second diameter but far less than said hand knob diameter, said working section extending through said second guiding portion of said base and protruding over said outer surface of base, and
said conical section having a conical shape for firmly securing.

2. The laser beam projection device as claimed in claim 1, wherein two fixing recessed are formed on or near said first end and said second end respectively.
